(19) United States
(12) Patent Application Publication
(10) Pub. No.: US 2015/0297031 A1
(43) Pub. Date: Oct. 22, 2015

(54) Fry Basket

(71) Applicant: PRINCE CASTLE LLC, Carol Stream, IL (US)

(72) Inventors: Scott R. Hammac, Joliet, IL (US); Cary Moreth, Bloomingdale, IL (US); Loren Veltrop, Chicago, IL (US); Charles Y. Choi, Chicago, IL (US); Jacob A. Stanton, Chicago, IL (US); Mark R. Pavel, Lisle, IL (US); Noah M. Wangerin, Chicago, IL (US); Hudson K. Rio, Chicago, IL (US); Joe T. Antoniolli, Carol Stream, IL (US); Nuttida Vanasin, Carol Stream, IL (US); Raul De Los Reyes, Carol Stream, IL (US); Chris Y. Xu, Carol Stream, IL (US)

(73) Assignee: PRINCE CASTLE LLC, Carol Stream, IL (US)

(21) Appl. No.: 14/690,928

(22) Filed: Apr. 20, 2015

Related U.S. Application Data
(60) Provisional application No. 61/981,286, filed on Apr. 18, 2014.

(51) Int. Cl. A47J 37/12

(52) U.S. Cl. CPC A47J 37/1295

(57) ABSTRACT

Fry baskets include a front end cap and a rear end cap opposed to the front end cap. First and second top rails are secured between the front and rear end caps at the tops of the front and rear end caps. First and second bottom rails are secured between the front and rear end caps at the bottoms of the front and rear end caps. A mesh panel secured between the first and second top rails. A handle assembly is configured to secure to the rear end cap.

### CROSS-REFERENCE TO RELATED APPLICATION

The present application claims priority of U.S. Provisional Patent Application No. 61/981,286, filed on Apr. 18, 2014, the content of which is hereby incorporated herein by reference in its entirety.

### BACKGROUND

The present disclosure is related to the field of food preparation. More specifically, the present disclosure is related to a basket for deep frying food.

In the food preparation industry, when a food item is to be deep fried, the food item is typically placed in a fry basket constructed of a wire frame and handle with a wound wire perimeter. The wires are welded together at each place that two or more wires intersect. This manufacture and welding process requires many steps and significant labor. Many food preparation facilities use a color identification system to identify different baskets or baskets for use at different restaurants. In order to provide this color identification, the handle of the fully assembled basket is dipped into Plastisol rubber plastic which adds further manufacturing and logistical steps.

In addition to the manufacturing challenges of current fry baskets, the wound wire and welded construction of the wire basket are susceptible to damage as the wires wrapped around the basket perimeter may bend, resulting in breakage of the welds, and creating spaces and/or holes in the basket through which food product may fall out.

Due to the rough conditions in which fry baskets are used, fry basket are typically replaced every 6-9 months. This results in a large number of new fry basket units being shipped both to sales and end user locations. The configuration and structural requirements of fry baskets tend to result in a large volume thereby increasing the space required to store and/or transport the fry baskets. This increases the cost associated with the storage and transportation of fry baskets. Therefore, fry baskets that achieve improved functionality of current fry baskets while resulting in a more compact volume are desired.

### BRIEF DISCLOSURE

A fry basket includes a front end cap. The front end cap has a top, a bottom, an interior surface, and an exterior surface. A rear end cap is opposed to the front end cap. The rear end cap includes a top, a bottom, an interior surface, and an exterior surface. A first top rail is secured between the front and rear end caps. A second top rail is secured between the front and rear end caps. A mesh panel is secured between the first top rail and the second top rail. First and second bottom rails are secured between the front end cap and rear end cap at the bottom of the front and rear end caps. A handle assembly is configured to secure to the rear end cap.

An additional embodiment of a fry basket includes a front end cap and a rear end cap. The front end cap includes a top, a bottom, an interior surface, and an exterior surface. The front end cap includes a plurality of perforations and an aperture therethrough. The rear end cap is opposed to the front end cap and further includes a top, a bottom, an interior surface, and an exterior surface. The rear end cap includes a plurality of perforations and an aperture therethrough. A first top rail is secured between the front and rear end caps. A second top rail is secured between the front and rear end caps. First and second bottom rails are secured between the front and rear end caps at the bottoms of the front and rear end caps. A mesh panel is secured between the first top rail and a second top rail. The mesh panel engages the first and second bottom rails and is held under tension between the first top rail and the second top rail. A handle assembly is securingly engaged to the rear end cap through the aperture of the rear end cap.

### BRIEF DESCRIPTION OF THE DRAWINGS

FIG. 1 is a perspective view of an embodiment of a fry basket.

FIG. 2 is an exploded view of the embodiment of the fry basket of FIG. 1.

FIG. 3 is a cut away view of an exemplary embodiment of nested fry baskets.

FIG. 4 is a close up view of an exemplary embodiment of a connector on a handle.

FIG. 5 is a perspective view of an additional exemplary embodiment of a fry basket.

FIG. 6 is an exploded view of the fry basket of FIG. 5.

FIG. 7 is a cut away view of an exemplary embodiment of nested fry baskets from the exemplarily embodiment of FIG. 5.

FIG. 8 is a cut away view of the fry basket of FIG. 5 taken along line 8-8.

FIG. 9 is a close up view of a portion of FIG. 8 denoted by line 9-9.

FIG. 10 is a perspective view of an additional exemplary embodiment of a fry basket.

FIG. 11 is an exploded view of the fry basket of FIG. 5.

FIG. 12 is a perspective view of an additional exemplary embodiment of an end cap of the fry basket of FIG. 10.

FIG. 13 is an exemplary embodiment of the front hanging hook of the embodiment of FIG. 10.

FIG. 14 is a perspective view of an attachment portion of the handle assembly of the embodiment FIG. 10.

FIG. 15 is a perspective view of a handle portion of the handle assembly of the embodiment of FIG. 10.

FIG. 16 is a side perspective view of an exemplary embodiment of a fry basket.

FIG. 17 is a front perspective view of the fry basket of FIG. 16.

FIG. 18 is a cross-sectional view taken along line 18-18 of FIG. 16.

FIG. 19 is a close up view of a portion of FIG. 18 denoted by line 19-19.

### DETAILED DISCLOSURE

Exemplary embodiments of fry baskets include a mesh stretched around a frame with a friction fitted handle and front hanging hook. The handle is configured to receive any one of a plurality of identification inserts which may exemplarily be color-coded to provide for different identifications.

In an additional embodiment, the fry basket is constructed of solid perforated end caps. Top rails are crimped over opposed ends of the mesh and the top rails are secured to the tops of the opposed end caps. The mesh is stretched to respective bottoms of the end caps and secured to the bottoms of the end caps with bottom rails. In an embodiment, the top rails and bottom rails are secured to the mesh and the end caps by crimping or with a clinched joint.

In embodiments, the front hanging hook and/or the handle may be constructed of pieces separate from the end caps and secured to the end caps with a friction or other mechanical fit.

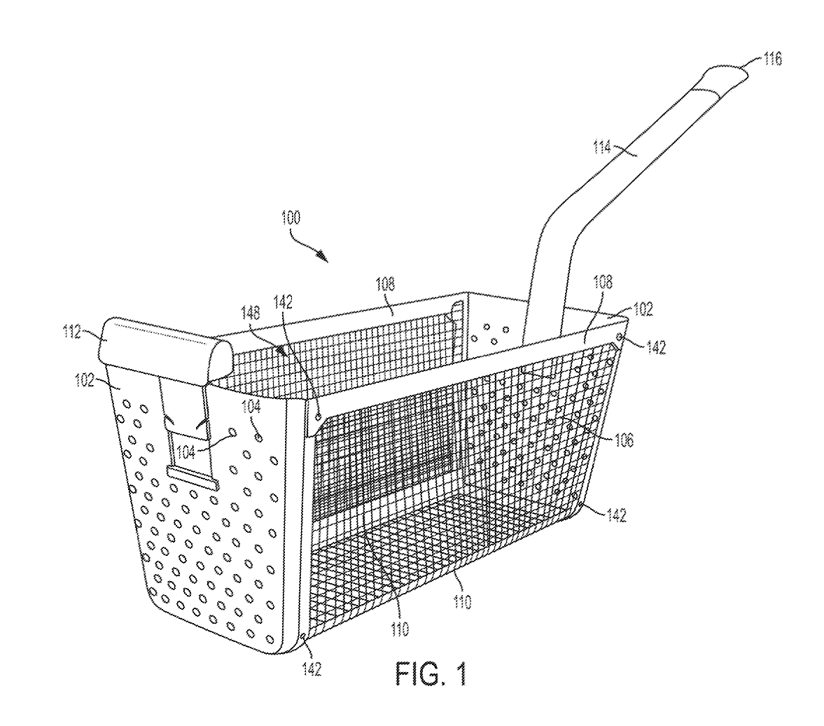

FIG. 1 is a perspective view of an exemplary embodiment of a fry basket 100. The fry basket 100 includes opposed end caps 102. In embodiments, the end caps 102 may be constructed of stainless steel and may include a plurality of perforations 104 punched or stamped therein to facilitate flow of cooking oil therethrough. In other embodiments, the end caps 102 may be constructed of other materials such as, but not limited to heat-resistant plastics or polymers, cast materials, or expanded metal mesh. The fry basket 100 further includes a mesh 106 that is stretched between opposed top rails 108 and as will be described in further detail herein, and around bottom rails 110 which also will be described in further detail herein. The mesh 106 in various embodiments may exemplarily take the forms of wire fabric mesh, pre-welded wire mesh, expanded metal, or perforated metal. In still further embodiments, plastic polymer, nylon or other non-metal materials may be used to construct the mesh 106.

The fry basket 100 includes a front hanging hook 112 that extends from a front end cap 102 and a handle 114 that extends from a back end cap 102. The handle 114 further includes an end cap 116. In embodiments, the identification insert 116 is constructed of plastic or other suitable material and is color coded exemplarily to indicate a use or location of the fry basket when it is in use. For example separate colors may be used to indicate fry basket dimensions or food product (e.g. French fires or chicken) cooked with that basket.

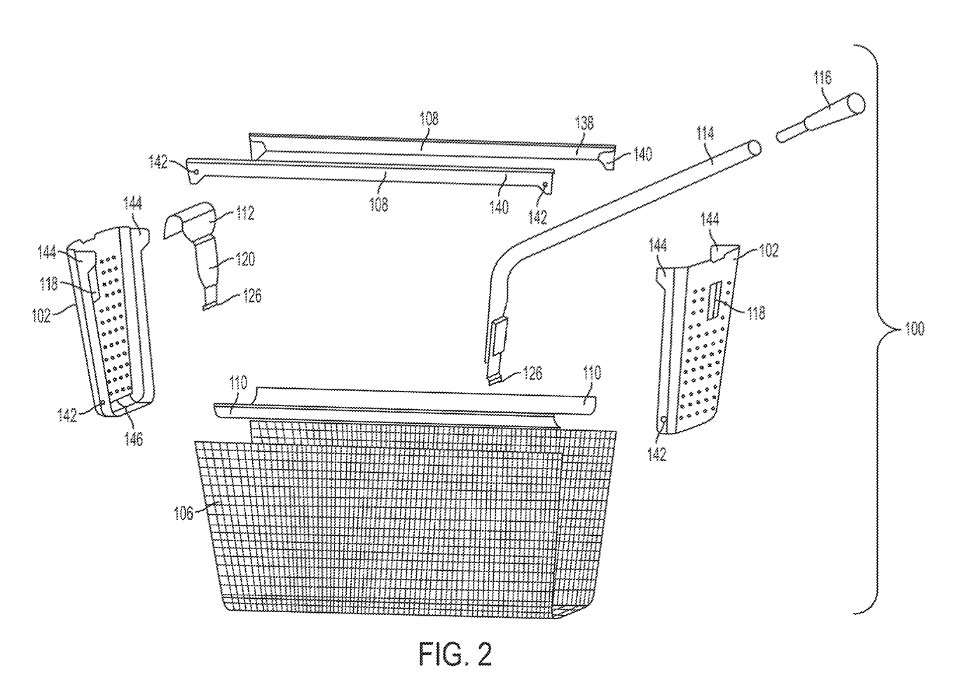

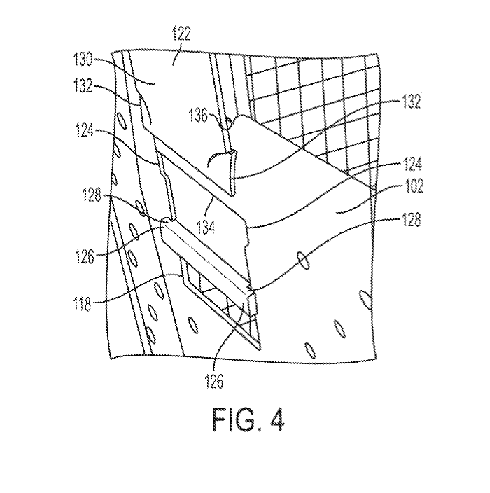

FIG. 2 is an exploded view of the fry basket 100. As can be better seen in FIG. 2, it will be recognized that the end caps 102 are symmetrical in construction and each include an aperture 118 that is configured to receive an attachment end 120 of the front hanging hook 112 or an attachment end 122 of the handle 114. The attachment ends 120 and 122 are configured to lockably secure through an aperture 118 to an end cap 102 using one or more of clipping or friction fit connections as will be explained in further detail herein. Specifically referring to FIG. 4, FIG. 4 is a close up view of an attachment end 122 of a handle inserted into an aperture 118 of an end cap 102. In the embodiment, the aperture 118 includes keyholes 124 through which fingers 126 of the attachment end 122 fit through the aperture and an interior surface 128 of the fingers 126 engage the outer surface of the end cap 102.

A top portion 130 of the attachment end 122 is configured to secure over the outer surface of the end cap 102 and resilient clips 132 that extend inwardly from the top portion 130 extend into the aperture 118, exemplarily in a region of the keyholes 124 and engage the top end 134 of the aperture 118. In an exemplary embodiment, the resilient clips 132 are stamped, punched, or cut from the top portion 130 of the attachment end 122. In an embodiment, the end cap 102 further includes a cut out 136 that is configured to receive a portion of the attachment end 122 when the attachment end is secured to the end cap 102 such that the attachment end is approximately flush with a top of the end cap 102.

Referring back to FIGS. 1 and 2, and as exemplarily described above, in construction, the mesh 106 is inserted between an interior side 138 and an exterior side 140 of the top rails 108. In an exemplary embodiment, the top rails 108 are crimped such as to secure the mesh 106 between the interior side 138 and the exterior side 140. The end caps 102 include inwardly projecting ledges 144 which extend inwardly from the exterior surface of the end caps 102. The opposed ends of the top rails 108 are exemplarily secured to the ledges 144 of the respective end caps 102 by crimping. In an embodiment, each ledge 144 is secured between the interior side 138 and the exterior side 140 of the ends of the top rails 108. In an additional embodiment the ledge 144 and the exterior side 140 are secured, and securement of the mesh 101 and interior side 138 at this location is optional. In embodiments, this joint is crimped or clinched. In an exemplary embodiment, a rivetless clinch joint, such as available from TOX Pressotechnik, LLC of Warrenville, Ill. may be used. It will be recognized that in other embodiments, the top rail 108 may be riveted or welded to the end cap 102.

The mesh 106 is pushed down from the top rails 108 until the mesh contacts a bottom lip 146 of the end caps 102. Bottom rails 110 are inserted into the basket interior 148 to secure the mesh 106 tightly or under tension against the bottom lip 146. The end caps 102, mesh 106, and bottom rails 110 are secured to each other exemplarily by the same manner as described above with respect to the top rails, exemplarily by crimping or clinching with joint 142. This secures the frame of the fry basket 100 as well as secures the mesh 106 thereto in order to form a basket configured to hold, cook, and retain food product during deep fry cooking.

Additionally, the frame of the fry basket 100 as assembled and disclosed herein is reinforced at the greatest points of wear or breakdown as discovered by the inventors. The end caps 102, top rails 108, and bottom rails 110, provide a solid, reinforced structural component at each edge or corner of the fry basket while the mesh allows for cooking oil circulation and drainage while reducing overall weight of the fry basket 100.

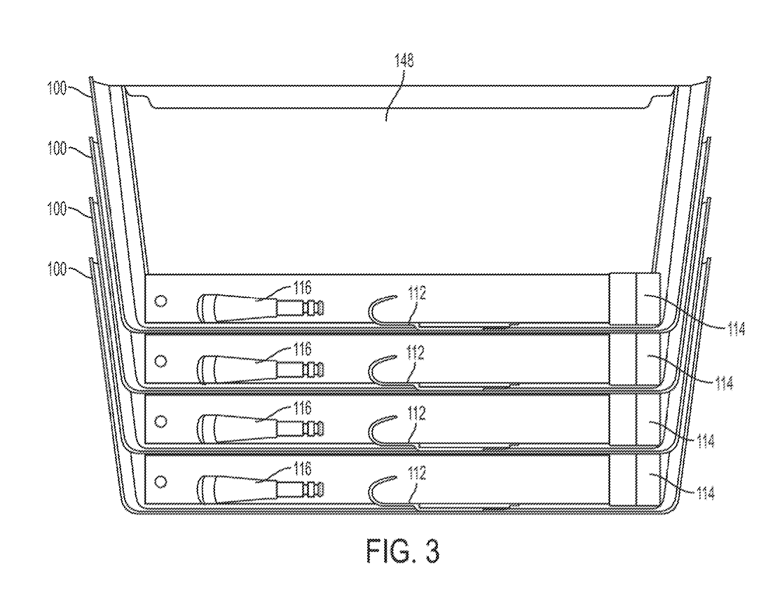

Referring now to FIG. 3, FIG. 3 is a cut away view of an exemplary embodiment of a plurality of fry baskets 100 that are in a nested configuration, exemplarily for shipping. As described above, previously available fry baskets have been constructed in a manner such that they present significant challenges and impediments to shipping, transport, or storage as the manufactured products take up a comparatively large volume for their weight and are therefore space-inefficient. Thus, embodiments of the fry baskets 100 as disclosed herein have separate components for the handle 114, end cap 116 and front hanging hook 112. As can exemplarily be seen in FIG. 3, such nesting arrangement enables the fry baskets 100 to be stored in a space-efficient manner for shipping, storage, or transport.

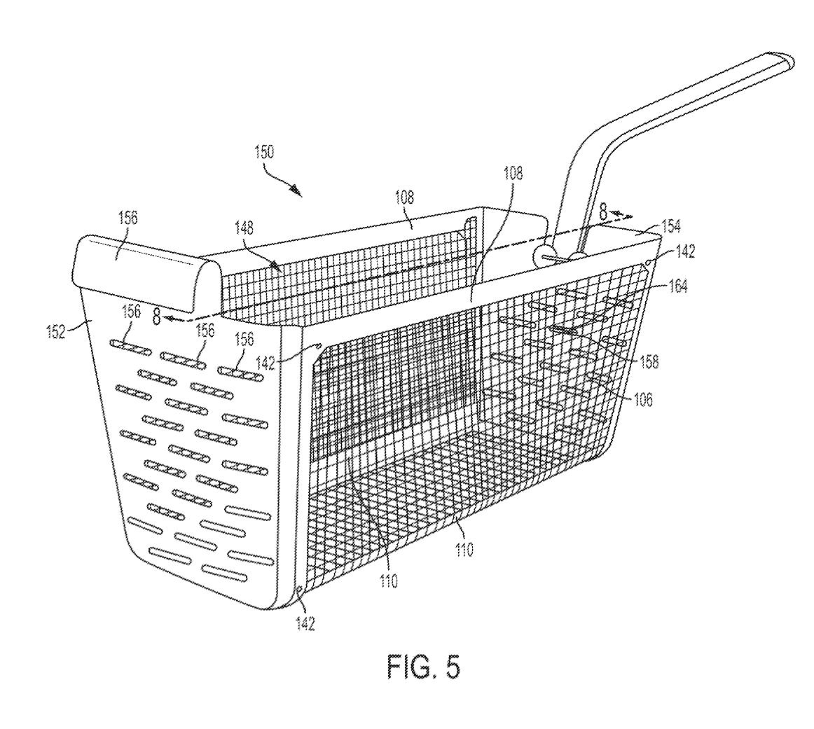

FIGS. 5-9 depict an exemplary additional embodiment of a fry basket 150. It will be recognized that the embodiment of the fry basket 150 is merely exemplary and that various combinations of features as disclosed between the various embodiments found herein may also be combined while remaining within the scope of the present disclosure. Furthermore, it will be recognized that like reference numerals have been used within the Figures as compared to FIGS. 1-4 in order to reference like features for the purpose of conciseness and to focus on particular features as depicted in FIGS. 5-9.

The fry basket 150 includes a front end cap 152 and a rear end cap 154. The front end cap 152 includes a unitary front hanging hook 156. In an embodiment, the unitary front hanging hook 156 is an integral structure of the front end cap 152. The front end cap 152 and the rear end cap 154 include perforations 156 which are exemplarily oblong in shape as opposed to the circular perforations exemplarily depicted in FIG. 1. It will be recognized that in still further embodiments other shapes of perforations of combinations of perforation shapes and/or sizes may be used, e.g. to achieve desired thermal circulation properties of the fry basket.

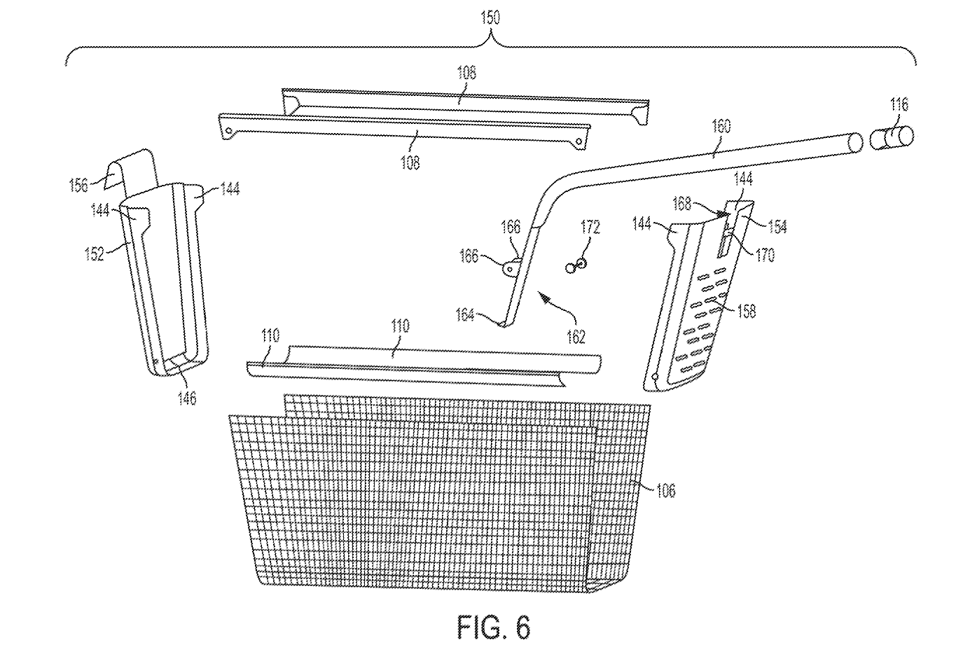

FIG. 6 depicts an exploded view of the fry basket 150 where particular attention is directed to the handle 160 and rear end cap 154. The handle 160 may be exemplarily constructed as a crushed metal tube in order to give the handle an oblong cross section. The inventors have found such a cross sectional shape to be ergonomically more desirable for a fry basket handle. Alternatively, the handle 160 may be constructed of a rolled piece of sheet metal in order to achieve a similar cross sectional shape. The handle 160 includes an attachment end 162 that includes a hook 164 and a pair of eyelets 166.

The rear end cap 154 includes an aperture 168 within which the handle 160 is disposed and through which the handle 160 extends. The rear end cap 154 further includes eyelets 170. The eyelets 170 exemplarily extend into the interior of the fry basket 150 from the rear end cap 154. A pivot pin 172 rotatably secures the handle 160 to the rear end cap 154 by threading through the eyelets 166 of the handle 160 and the eyelets 170 of the rear end cap 154. Alternative embodiments may include a pair of pivot pins or pivot features extending inwardly or outwardly from the projections of the eyelets, about which the handle 160 is pivotable. In the embodiment of FIG. 6, the handle 160 is pivotable about the pivot pin 172 between a closed or stored position and an open or use position.

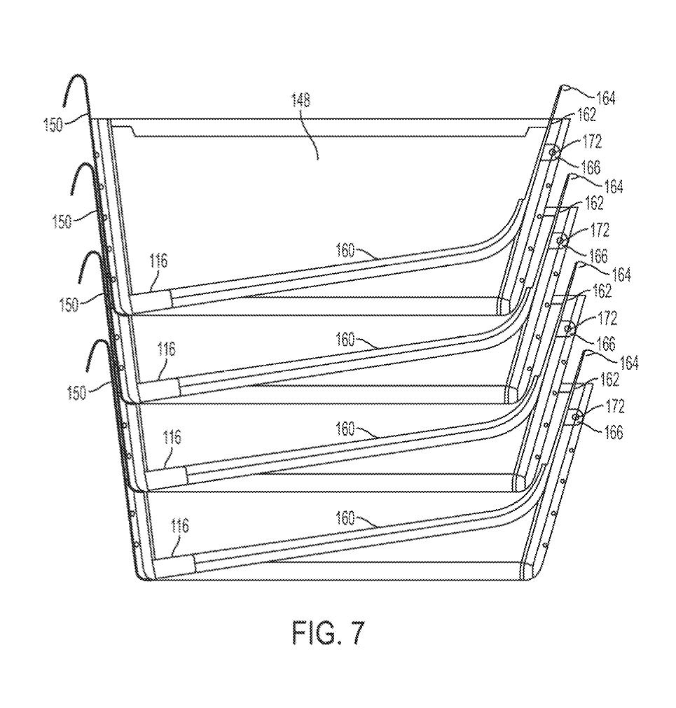

While the handle 160 is pivoted into the closed or stored position for storage and/or transport before use, as will be described in further detail herein with respect to FIG. 7, when the fry basket 150 is to be used (e.g. in food service preparation) the handle 160 is pivoted into the open or use position about the pivot pin 172. As the handle 160 is pivoted into the open or use position, the attachment end 162 moves into engagement with an exterior of the rear end cap 154. The hook 164 extends through an aperture 158 which is exemplarily one of the perforations 156 in the rear end cap 154. Although, it will be recognized that in embodiments, the aperture 158 may be shaped differently than the other perforations to facilitate engagement with the attachment end 162 of the handle 160.

FIG. 7 is a cut away view of a plurality of fry baskets 150 in a nested configuration for shipping or storage. The handles 160 of the fry baskets 150 are shown in the closed or storage configuration where the handle 160 is pivoted about the pivot pin 172 such that the handle 160 is folded into the interior of the fry basket 150.

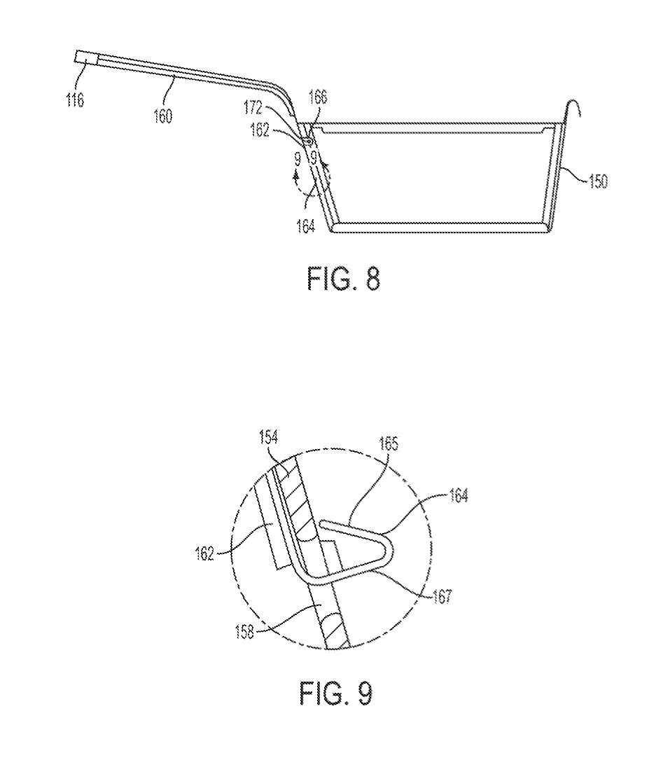

FIG. 8 is a cut away view of the fry basket 150 taken along line 8-8 of FIG. 5. FIG. 8 depicts the fry basket 150 in the open or use configuration. In this configuration, the handle 160 is pivoted about the pivot pin 172 such that the handle 160 is exterior of the interior of the fry basket 150 and the attachment end 162 is in engagement with the exterior of the rear end cap 154. The hook 164 extends through the aperture 158 and engages an interior side of the rear end cap 154.

FIG. 9 is a close up view of the region of FIG. 8 denoted by line 9-9. Referring to FIGS. 8 and 9, the hook 164 at the attachment end 162 of the handle 160 can be configured such as to lockingly secure through the aperture 158 to secure the hook 164 into engagement with an interior side of the rear end cap 154. In an exemplary embodiment, the hook 164 may be configured to be resiliently deformable, particularly responsive to motion and/or forces to move the handle 160 into the open or use configuration. In an exemplary embodiment, an arm 165 of the hook 164 is exemplarily deflectable towards a base 167 of the hook 164 such that the arm 165 can move past the rear end cap 154. Once the hook 164 has moved past the rear end cap 154, the arm 165 may again return to its original position or shape such that at least a portion of the arm 165 extends beyond the aperture 158 and into position adjacent with or in engagement with the interior side of the rear end cap 154. With this positioning, the handle 160 is not rotatable back to the closed or storage configuration and rather may only be moved if the arm 165 can be deflected towards the base 167 in order to move the arm 165 through the aperture 158 past the rear end cap 154. In still further embodiments, engagement of the hook 164 with the rear end cap 154 may be further facilitated by some deformation by the rear end cap 154 to facilitate the movement of the arm 165 past the rear end cap 154 and into engagement therewith.

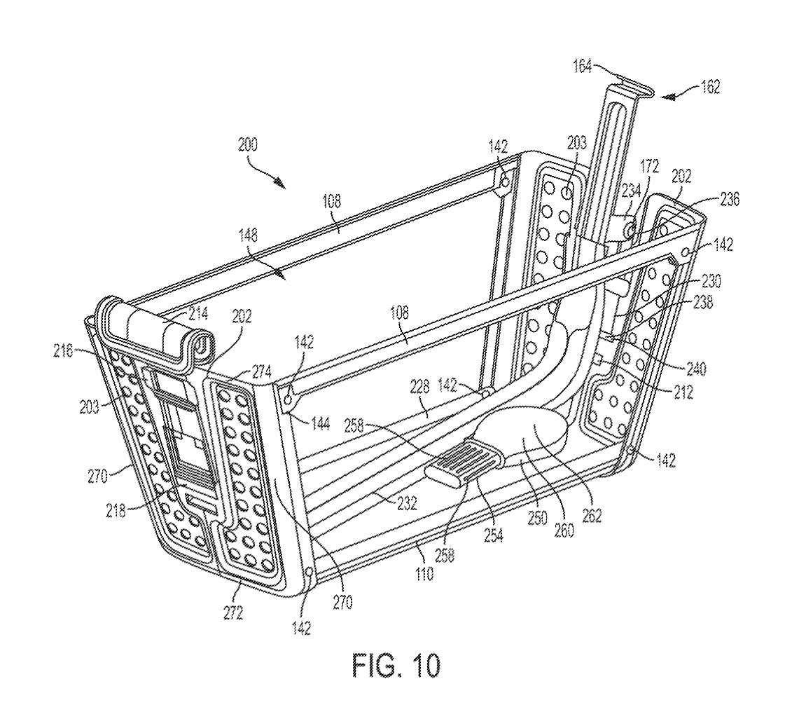

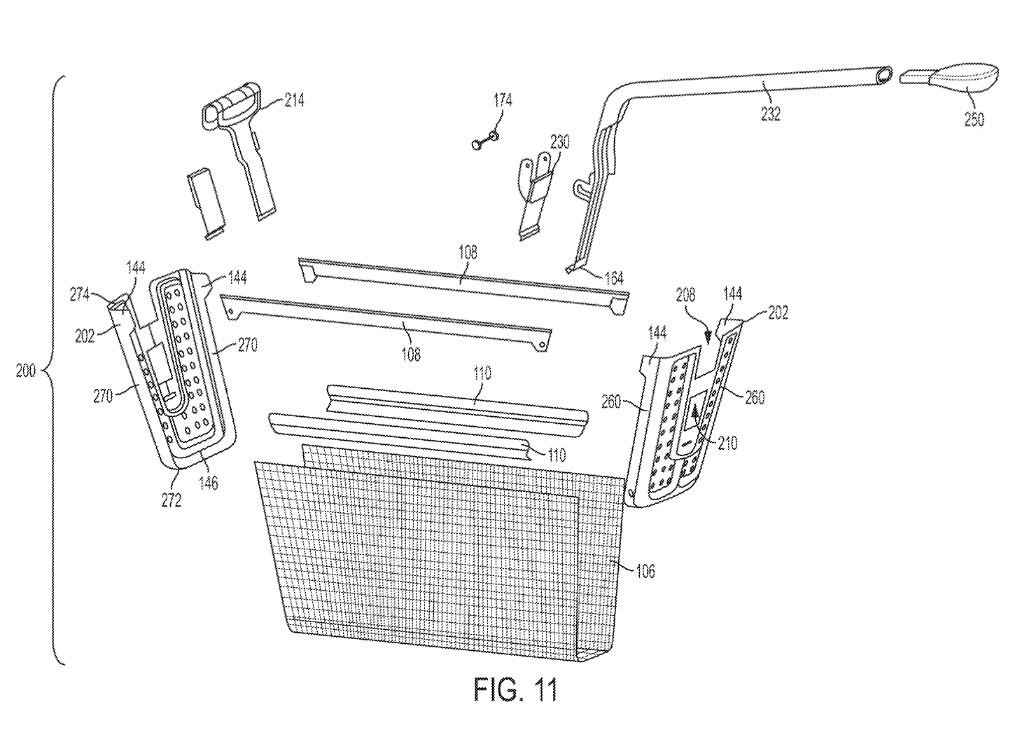

FIG. 10 depicts a still further exemplary additional embodiment of a fry basket 200. FIG. 11 is an exploded view of the embodiment of the fry basket 200 of FIG. 10. As previously recognized with other embodiments as disclosed herein, various components as described with respect to this merely exemplary embodiment may be used with features of other embodiments to achieve a fry basket within the scope of the present disclosure. Like reference numerals are used with respect to this embodiment compared to other embodiments for the purpose of conciseness.

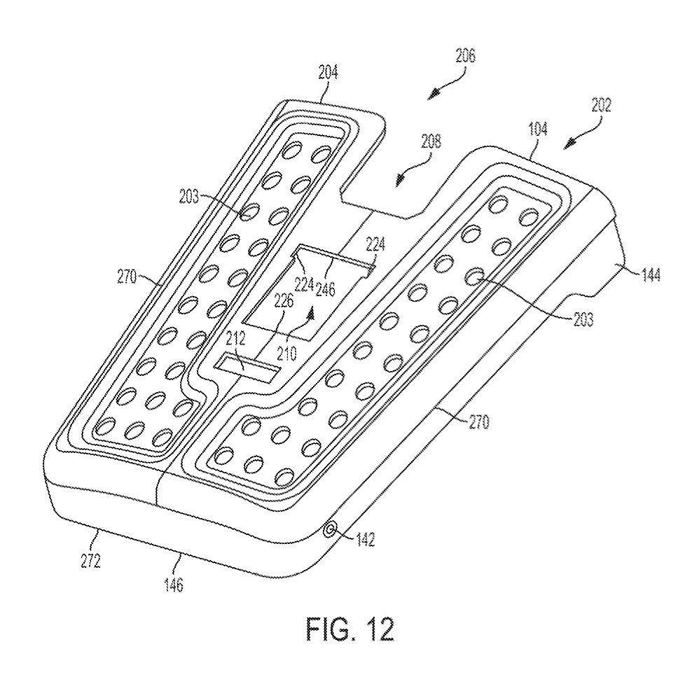

Referring to FIGS. 10-12, FIG. 12 depicts an embodiment of an end cap 202. In the exemplary embodiment of the fry basket 200, the end caps 202 are exemplarily symmetrical and the same design used as both the front end cap and the rear end cap. The end cap 202 exemplarily comprises a plurality of perforations 203 as previously described above. The end cap 202 includes a strengthening rib 204 that is exemplarily stamped into the stainless steel plate of the end cap 202 to increase the strength and rigidity of the end cap 202 and the fry basket 200 as a whole. While not intended to be limiting, the end cap 202 may also be constructed of a heat-resistant plastic or polymer, and exemplarily formed by injection molding. The strengthening rib 204 defines a center section 206 that includes three apertures, exemplarily a top aperture 208 a center aperture 210 and a lower aperture 212. The apertures 208, 210 and 212 are configured and used as described in further detail herein.

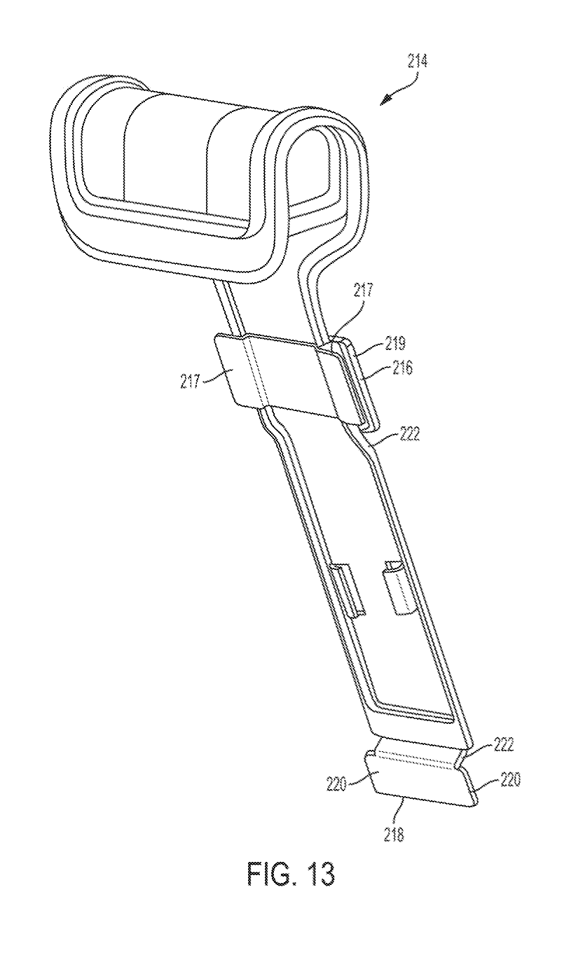

FIG. 13 is a perspective view of an exemplary embodiment of a front hanging hook 214. The front hanging hook 214 is configured to slidably and resiliently engage the end cap 202. Exemplarily, the front hanging hook 214 includes top fingers 216 that slidably engage the end cap 202 at the top aperture 208. Exemplarily, the top fingers 216 include exterior fingers 217 and interior fingers 219 which sandwich the end cap 202 therebetween in the region of the top aperture 208. The front hanging hook 214 further includes a bottom finger 218 that extends from a lower most portion of the front hanging hook 214. The bottom finger 218 includes tabs 220 which extend laterally outward from the bottom finger 218. Bends 222 shape the front hanging hook 214 such that while the top fingers 216 and the bottom fingers 218 and tabs 220 engage the exterior of the end cap 202, a portion of the front hanging hook 214 extends along the interior surface of the end cap 202.

The bottom finger 218 and tabs 220 are configured along with the center aperture 210 of the end cap 202 to receive the bottom finger 218 and tabs 220 through keyholes 224 in the center aperture 210 and the bottom finger 218 and tabs 220 slidingly engage the outer surface of the end cap until the bottom finger 218 and tabs 220 engage a bottom end 226 of the center aperture 210 to secure the front hanging hook 214 to the end cap 202 by a friction fit.

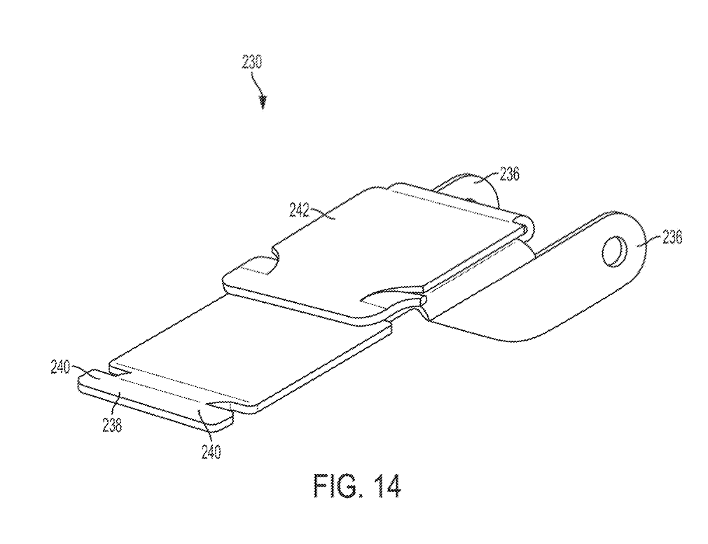

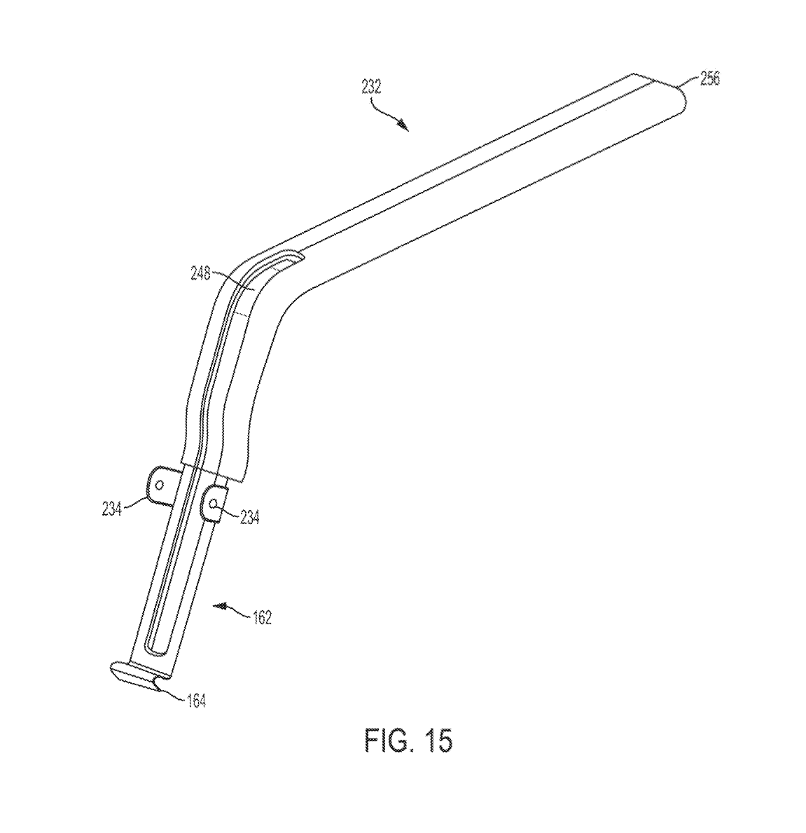

FIGS. 14 and 15 depict portions of the handle assembly 228. The handle assembly 228 includes an attachment portion 230 which is depicted in a perceptive view in FIG. 14 and a handle portion 232 which is exemplarily depicted in perspective in FIG. 15. The attachment portion 230 is secured to the handle portion 232 by a pivot pin 172 that pivotably connects the handle portion 232 to the attachment portion 230 by threading through respective handle eyelets 234 and attachment eyelet 236.

The attachment portion 230 includes a finger 238 that is configured to extend through the center aperture 210 in the end cap 202 and resiliently engage an interior surface of the end cap 202 at the bottom end 226 of the center aperture 210. In embodiments, the finger 238 includes laterally extending tabs 240 that are configured to fit through the keyholes 224 of the center aperture 210 and to also resiliently engage the interior surface of the end cap 202. The attachment portion 230 further includes a top portion 242 which extends through the top aperture 208 of the end cap 202 and extends over the outer face of the end cap 202. Resilient clips 244 extend into the center aperture 210 and engage a top end 246 of the center aperture, exemplarily within the keyholes 224 to secure the top portion 242 against the end cap 202.

The handle portion 232 depicted in FIG. 14 includes a strengthening rib 248 in order to provide additional rigidity and strength to the handle portion 232. Strengthening rib 248 further demonstrates that in embodiments, strengthening ribs may be depressions (when viewed from one side) or outwardly protruding (e.g. when viewed from another side). The handle portion 232 includes a hook 164 at an attachment end 162. The hook 164 is configured to extend through the end cap 202 in a direction from the exterior into the interior and resiliently engage the interior surface of the end cap to lock the handle portion 232 in an open or use configuration. As described above, the handle portion 232 includes attachment eyelets 236 and a pivot pin 172 is threaded through the handle eyelets 234 and the attachment eyelets 236 to pivotably secure the handle portion 232 to the attachment portion 230. When the handle assembly 228 is assembled, the attachment portion 230 secures the handle assembly to the end cap 202 of the fry basket 200 and the handle portion 232 is pivotable about the pivot pin 172 between a storage configuration wherein the handle portion 232 is substantially within the interior of the fry basket 200 and an open or use configuration wherein the handle portion 232 is rotated exterior of the fry basket 200 and the hook 164 locks the handle portion in the open configuration. In an embodiment, the handle portion rotates about the pivot pin 172 and the attachment portion 230 through the top aperture 208 of the end cap 202. In an exemplary embodiment, this serves the additional function of lowering the point of rotation between the handle assembly and the rest of the fry basket 200 which may facilitate improved ease of use for a user lifting the fry basket 200. Additionally, this feature can further reduce a height that the attachment end 162 extends above the end cap 202 when the handle assembly is in the closed or storage configuration.

Referring back to FIG. 10, an alternative embodiment of an identification insert 250 is depicted which is configured to be inserted into an open end of the handle portion 232. As discussed above, the identification insert 250 may exemplarily be constructed of a plastic or other polymeric material and color coded to specify a use or location of use for the fry basket 200. The identification insert 250 includes an insertion portion 254 that is configured to be inserted into an open end 256 of the handle portion 232. The insertion portion 154 may further include one or more friction elements 258, which are exemplarily rigid, but may be any of a variety of other structural features that operate to increase a friction fit between the insertion portion 254 and the interior of the handle portion 232 at the open end 256.

Additionally, the identification insert 250 may be constructed with an ergonomic design that exemplarily includes a narrow portion that is configured to exemplarily match the dimension of the handle portion 232 at the open end 256 and then widen and flatten at a user end 262 to foster comfort and engagement with the user's arm when the user uses a particular common grip of fry baskets. In an embodiment, this grip is an overhand grip wherein the end cap 250 engages a bottom of the user forearm while the user grips the handle portion 232 at a position proximal to the fry basket 200 from the identification insert 250. Particularly, when the user has limited upper body strength, this grip can facilitate movement and control of the fry basket 200 when filled with food product. The exemplary embodiment of the identification insert 250 promotes comfort and improves stability for a user using this grip.

With further reference to FIGS. 10-12, the embodiment of the fry basket 200, and particularly, the end cap 202 may further be constructed of multiple pieces rather than of a single unitary construction. In such an embodiment, the end cap 202 includes corner rails 270 which exemplarily include the ledges 144 and a bottom 272 which include the bottom lip 146. In such a construction, the corner rails 270 and the bottom 272 may be subcomponents, or may represent a unitary construction. In such embodiments, the perforated portion of the end cap 202 may exemplarily be provided as a mesh (not depicted) secured between the structures exemplarily in the manner as described in the present application regarding the mesh 106. In exemplary embodiments, the mesh 106 itself may extend up the ends represented by the front and rear end caps 202. In either of these embodiments, the joint 142, exemplarily located with respect to the corner rails 270 and/or bottom 272 may further secure the mesh across the end cap 202. It is further recognized that embodiments of the end caps may include a top 274 or other structure which in an embodiment may be provided by the strengthening rib 204 to which the mesh is further secured. In embodiments, interiorly located rails, for example similar to bottom rails 110 may be positioned interior of the end caps 202, exemplarily along ledge 146 or interior of the corners 270 to secure the mesh therebetween.

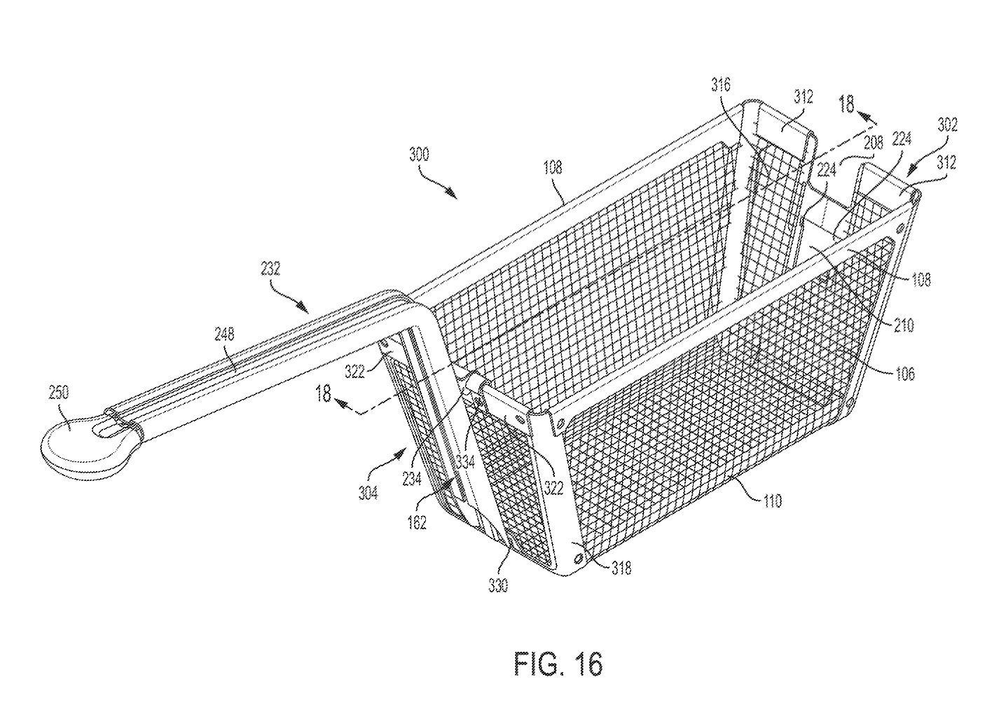

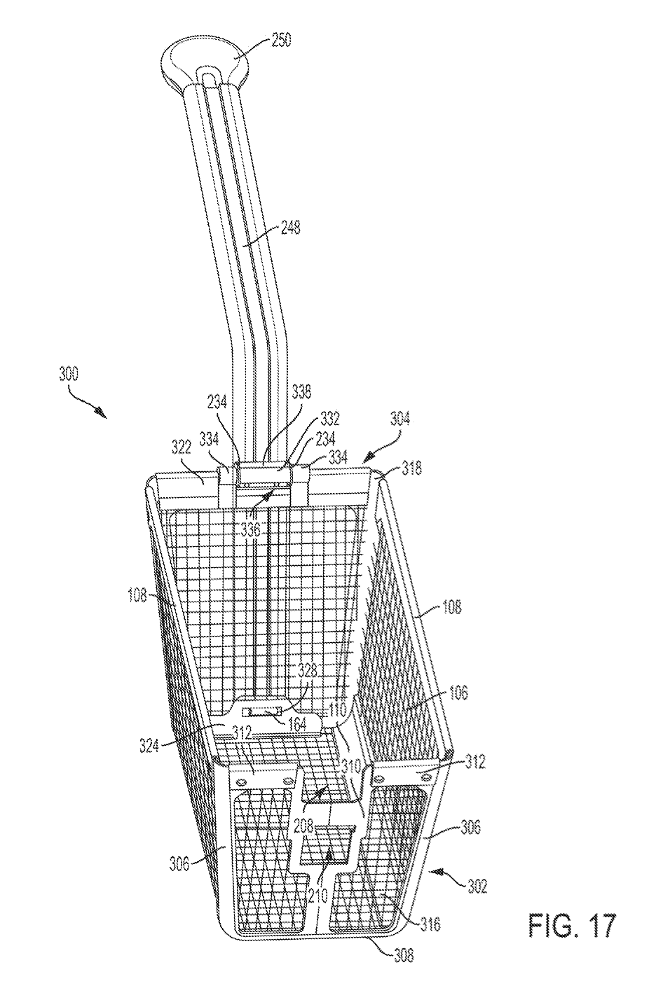

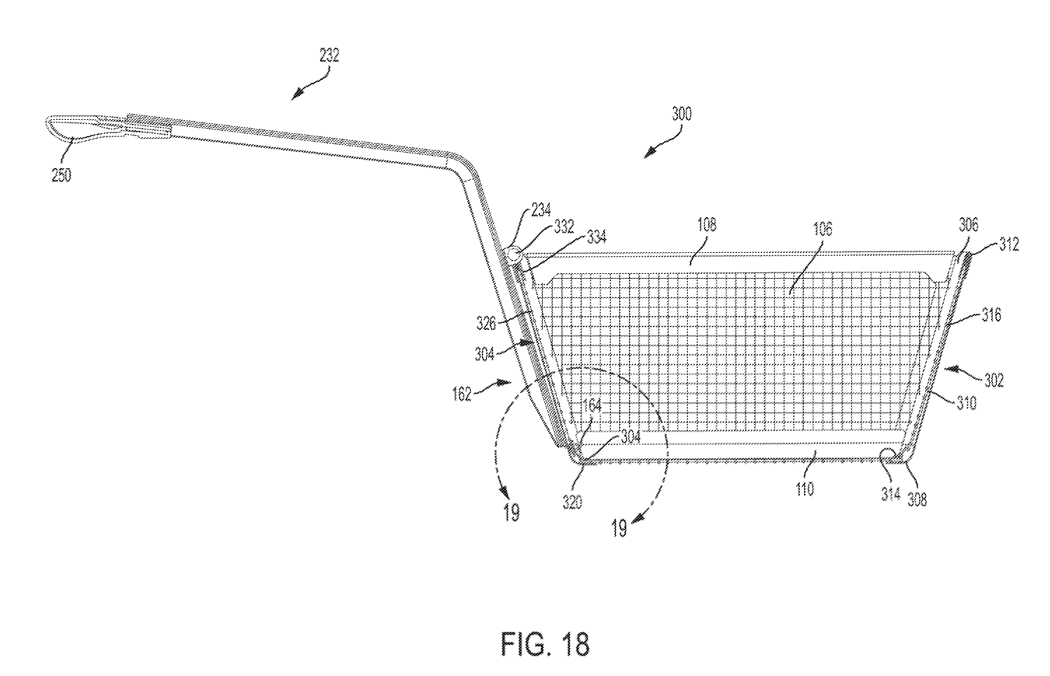

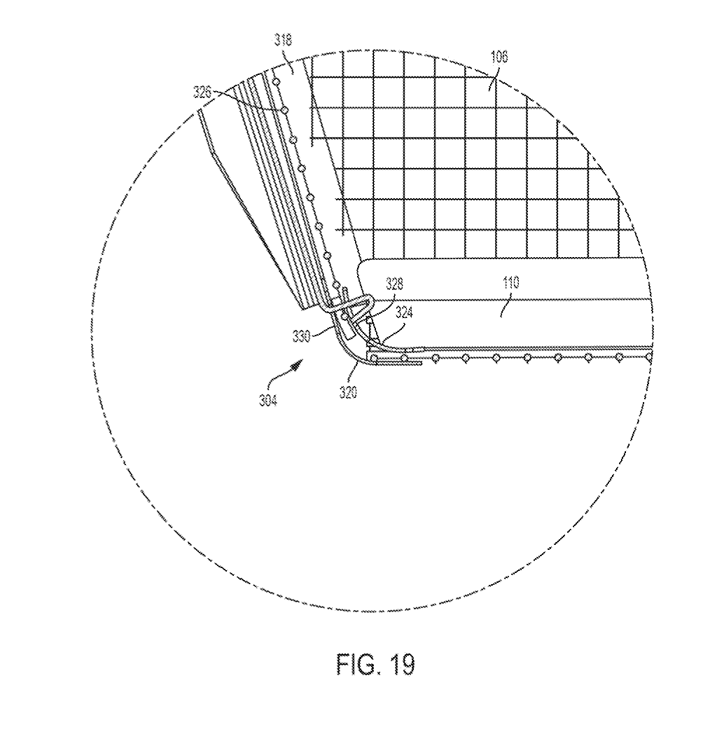

FIGS. 16-19 depict a still further exemplary embodiment of a fry basket 300. FIG. 16 is a side perspective view of the fry basket 300. FIG. 17 is a front perspective view of the fry basket 300. It will be recognized that reference numerals common to the Figures and descriptions above used with respect to FIGS. 16-19 are used to identify like features as previously described.

The fry basket 300 includes top rails 108 which are secured to mesh 106 in the manner as described above, being secured around bottom side rails 110. The top side rails 108 and bottom side rails 110 are secured to a front end cap 302 and a rear end cap 304. The front end cap 302 is exemplarily constructed of corner rails 306, a front exterior bottom rail 308 and an interior frame 310. In the embodiment depicted, the interior frame 310 includes aperture 208 and aperture 210 as previously described above. Front top rails 312 and front interior bottom rail 314 secure a front mesh 316 to the interior frame 310, exemplarily by crimping, clinching, or otherwise as described above. It will be recognized that the aperture 208 and aperture 210 may be configured in such a manner to receive e.g. a front hanging hook as previously described. While the front end cap 302 has been described herein as being constructed of a plurality of components, it will be recognized that the front end cap may also be constructed comprising a unitary structure including the side rails 306, front exterior bottom rail, and interior frame 310. In such an exemplary embodiment, the structure may be constructed of stamped and/or formed sheet metal, or other materials as described above.

The rear end cap 304 includes side rails 318, a rear exterior bottom rail 320, and a rear top rail 322. While depicted in FIGS. 16-19 as separate structures, similar to that as described above with respect to the front end cap 302, the side rails 318, rear exterior bottom rail 320 and rear top rail 322, or any combinations thereof may be constructed as a unitary piece. In an exemplary embodiment, the side rails 318 and rear exterior bottom rail 320 are constructed as a single piece to which the rear top rail 322 is secured.

A rear interior bottom rail 324 is exposed on the interior side of the fry basket 300 and a rear mesh 326 is secured to the rear end cap 304 by being secured between the rear top rail 322 and the rear interior bottom rail 324. The rear mesh 326 is exemplarily secured between both sides of the rear top rail 322 and clinched therein exemplarily by a crimp or clinch joint. Similarly, the rear mesh 326 is secured between the rear exterior bottom rail 320 and the rear interior bottom rail 324. Again, the mesh 326 may exemplarily be secured by crimping or clinching of portions of the rear exterior bottom rail 320 and rear interior bottom rail 324 together.

While the mesh 106, front mesh 316, and rear mesh 326 have been described herein as separate pieces, a person of ordinary skill in the art will recognize that in another embodiment such components may all be provided as a unitary piece of mesh or a single piece of mesh that is formed or shaped, exemplarily into a basket shape or into a cross shape for configuration herein.

The rear interior bottom rail 324 further includes an aperture 328 therethrough. The rear exterior bottom rail 320 includes an aperture 330 therethrough. In exemplary embodiments, the apertures 328 and 330 are rectangular although this is not intended to be limiting on the shape of apertures as may be used within the scope of the present disclosure.

The fry basket 300 includes a handle portion 232 that is clearly connected to the rear top rail 322 in the manner as disclosed in further detail herein. The handle portion 232 exemplarily includes a strengthening rear rib 248 and an identification insert 250 as previously described above. The handle portion 232 extends away from an attachment end 162 at a generally obtuse angle. The handle portion 323 and attachment end 162 may exemplarily be constructed of rolled metal that is crushed or deformed to achieve the shapes as shown and described herein. The attachment end 162 includes a hook 164 that is configured to extend through the aperture 330 in the rear exterior bottom rail 320 as well as at least partially through the aperture 328 of the rear interior bottom rail 324. In an exemplary embodiment, the hook 164 operates generally in the manner as described above with respect to FIG. 9 while it will be recognized that in one embodiment, when the handle portion is in the use position that the hook 164 engages the rear exterior bottom rail 320 while in another embodiment, the hook 164 engages the rear interior bottom rail 324 although other configurations are considered to be within the scope of the present disclosure.

The attachment end 162 is pivotably secured to the top rail 322 in an manner such that the handle portion 232 and attachment end 162 may rotate about a pivot rod 332. The pivot rod 332 is secured to the rear top rail 322 by a pair of rod clamps 334 which extend at least partially around the pivot rod 332 and are secured to the rear top rail 322 exemplarily by crimp or clinch joints.

In an embodiment, the rear top rail 322 includes an aperture 336 within which the pivot rod 332 is secured. In an exemplary embodiment, the pivot rod 332 is exemplarily located within the aperture 336 such that a top of the pivot rod 332 is coplanar with the top of the rear top rail 322. The rod clamps 334 extend about an area of the aperture 336 to secure the pivot rod 332 within the aperture 336. A pair of eyelets 234 are secured about the pivot rod 332 and to the attachment end. As described in other embodiments, the attachment end 162 and the handle portion 232 may be instructed of rolled and otherwise formed sheet metal. In one embodiment, eyelets 234 are secured to an attachment bar 338 which is then secured to the attachment end 162. The moveable engagement between the eyelets 234 and the pivot rod 332 enables the handle portion to rotate about the pivot rod 332 and into the interior of the fry basket 300 for efficient transport or storage.

In embodiments constructed of heat-resistant plastic or polymeric materials, the joints between the fry basket structures and the mesh of the basket may include crimped or crushed joints, rivotless clinch joints, ultrasonic welding, heat treatments, or a combination of the above. In still further embodiments the mesh may be secured to the structure of the basket by injection molding.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A fry basket comprising:
a front end cap having a top, a bottom, an interior surface, and an exterior surface;
a rear end cap opposed to the front end cap and further having a top, a bottom, an interior surface, and an exterior surface;
a first top rail secured between the front and rear end caps;
a second top rail secured between the front and rear end caps;
a mesh panel secured between the first top rail and the second top rail;
first and second bottom rails secured between the front and rear end caps at the bottoms of the front and rear end caps; and
a handle assembly configured to secure to the rear end cap.

2. The fry basket of claim 1, wherein the mesh panel engages the first and second bottom rails.

3. The fry basket of claim 2, wherein the mesh panel is held under tension between the first and second top rails, first and second bottom rails, and the front and rear end caps.

4. The fry basket of claim 3, wherein the first and second top rails each comprise a first side and a second side, and mesh panel is secured intermediate the first side and the second side of the first top rail and the mesh panel is secured intermediate the first side and the second side of the second top rail.

5. The fry basket of claim 3, wherein the first and second bottom rails are first and second exterior bottom rails, and further comprising first and second interior bottom rails;
wherein the mesh panel is secured intermediate the first exterior bottom rail and the first interior bottom rail and the mesh panel is secured intermediate the second exterior bottom rail and the second interior bottom rail.

6. The fry basket of claim 1, wherein the front and rear end caps comprise a plurality of perforations therethrough and the rear end cap comprises at least one aperture through which the handle assembly securingly engages the rear end cap.

7. The fry basket of claim 6, wherein the front and rear end caps are each constructed of a unitary piece of solid material through which the perforations are formed, and the front end cap comprises at least one aperture configured to securingly engage the handle assembly.

8. The fry basket of claim 6 wherein the front and rear end caps comprise mesh secured to the front and rear end caps, the mesh comprising the plurality of perforations.

9. The fry basket of claim 8, wherein the mesh secured to the front and rear end caps is the mesh panel.

10. The fry basket of claim 6 further comprising:
a hook assembly comprising a hook, a bottom portion comprising at least one finger, and a top portion comprising at least one clip;
wherein the front end cap further comprises an aperture and the at least one finger of the hook assembly securingly engages a bottom of the aperture through the front end cap and the clip of the hook assembly securingly engages a top of the aperture through the front end cap.

11. The fry basket of claim 6 wherein the handle assembly comprises a handle portion comprising an elliptic cylinder, an attachment portion, and an identification insert secured to the handle portion.

12. The fry basket of claim 6, further comprising:
at least one end cap eyelet secured to the rear end cap in a region about the at least one aperture;
at least one handle eyelet secured to the handle assembly; and
a pivot pin threaded through the at least one end cap eyelet and the at least one handle eyelet;
wherein the handle assembly is rotatable about the pivot pin between a first position wherein the handle assembly is folded into an interior of the fry basket and a second position wherein the handle assembly extends away from the interior of the fry basket.

13. The fry basket of claim 12, wherein the attachment portion comprises a finger, and in the second position, the finger extends through the rear end cap and engages the interior surface of the rear end cap to secure the handle assembly in the second position.

14. The fry basket of claim 1, wherein the handle assembly comprises a handle portion and an attachment portion, the attachment portion further comprising at least one finger configured to extend through the rear end cap to engage the interior surface of the rear end cap to secure the handle assembly to the rear end cap.

15. The fry basket of claim 1, wherein the mesh panel is constructed of a material selected from wire fabric, welded wire, expanded metal, perforated metal, plastic, polymer, and nylon.

16. A fry basket comprising:
a front end cap having a top, a bottom, an interior surface, and an exterior surface, the front end cap comprising a plurality of perforations and an aperture therethrough;
a rear end cap opposed to the front end cap and further having a top, a bottom, an interior surface, and an exterior surface, the rear end cap comprising a plurality of perforations and an aperture therethrough;
a first top rail secured between the front and rear end caps;
a second top rail secured between the front and rear end caps;
first and second bottom rails secured between the front and rear end caps at the bottoms of the front and rear end caps;
a mesh panel secured between the first top rail and the second top rail, the mesh panel engages the first and second bottom rails and is held under tension between the first top rail and the second top rail; and
a handle assembly securingly engaged to the rear end cap through the aperture of the rear end cap.

17. The fry basket of claim 16 wherein the front end cap and the rear end cap have the same structure and configuration.

18. The fry basket of claim 16, wherein the first and second bottom rails are first and second exterior bottom rails, and further comprising first and second interior bottom rails;
wherein the mesh panel is secured intermediate the first exterior bottom rail and the first interior bottom rail and the mesh panel is secured intermediate the second exterior bottom rail and the second interior bottom rail.

19. The fry basket of claim 16, wherein the front end cap, rear end cap, first and second top rails, first and second bottom rails, and mesh panel are secured to one another with crimped joints.

20. The fry basket of claim 16 further comprising:
a hook assembly comprising a hook, a bottom portion comprising at least one finger, and a top portion comprising at least one clip;
wherein the at least one finger of the hook assembly securingly engages a bottom of the aperture through the front end cap and the clip of the hook assembly securingly engages a top of the aperture through the front end cap.
